(19) United States
(12) Patent Application Publication
(10) Pub. No.: US 2004/0038708 A1
(43) Pub. Date: Feb. 26, 2004

(54) Method for playing game over mobile communication network

(76) Inventors: Shih-Kuang Tsai, Taipei Hsien (TW); Yung-Chun Feng, Shanghai (CN)

Correspondence Address: NAIPO (NORTH AMERICA INTERNATIONAL PATENT OFFICE), P.O. BOX 506, MERRIFIELD, VA, 22116, US

(21) Appl. No.: 10/064,815

(22) Filed: Aug. 21, 2002

(51) Int. Cl. H04B 1/38

(52) U.S. Cl. 455/557

(57) ABSTRACT

A method for a user to play a game stored on a first mobile communication device over a mobile communication network includes connecting the first mobile communication device to a server of the mobile communication network in order to play the game over the mobile communication network and disconnecting the first mobile communication device with the server when the game is finished. The user of the mobile communication device can play games with other players or with computer-simulated players through the server to make the game more enjoyable and to provide revenue-earning opportunities to owners of mobile communication networks.

### BACKGROUND OF INVENTION

1. Field of the Invention

The present invention relates to a mobile communication device, and more specifically, to a mobile communication device used for playing games over a mobile communication network.

2. Description of the Prior Art

Currently, a user of a mobile communication device can play single-player games that locally reside on the mobile communication device. For convenience, a cellular phone will be used to represent all mobile communication devices throughout the remainder of this disclosure. Unfortunately, without interaction from other players, a user of a cellular phone may quickly become bored with the game. In addition, single player games that reside locally on the cellular phone offer no revenue-earning opportunities to owners of cellular phone networks since no calls need to be made to the cellular phone network in order to play the game.

### SUMMARY OF INVENTION

It is therefore a primary objective of the claimed invention to provide a method for a user to play a game stored on a first mobile communication device over a mobile communication network in order to solve the above-mentioned problems.

According to the claimed invention, a method for a user to play a game stored on a first mobile communication device over a mobile communication network includes connecting the first mobile communication device to a server of the mobile communication network in order to play the game over the mobile communication network and disconnecting the first mobile communication device with the server when the game is finished.

It is an advantage of the claimed invention that the user of the mobile communication device can play games with other players or with computer-simulated players through the server to make the game more enjoyable and to provide revenue-earning opportunities to owners of mobile communication networks.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a diagram of a first mobile communication device connecting with a second mobile communication device through a server according to the present invention.

FIGS. 2A to 2C show a flowchart illustrating playing a game over a mobile communication network according to the present invention.

FIGS. 3A to 3C show a flowchart illustrating playing a guessing game over the mobile communication network according to the present invention.

### DETAILED DESCRIPTION

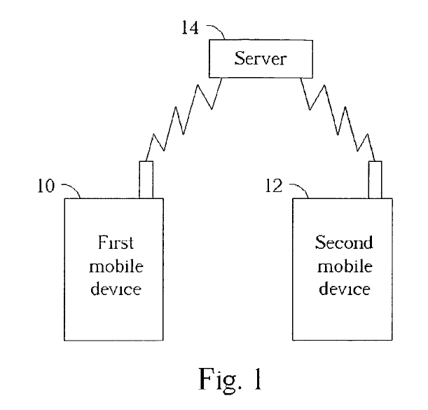

Please refer to FIG. 1. FIG. 1 is a diagram of a first mobile communication device 10 connecting with a second mobile communication device 12 through a server 14 according to the present invention. As mentioned above, for convenience, a cellular phone will be used to represent all mobile communication devices throughout the remainder of this disclosure. In order to realize the present invention, only a few short steps are needed. If a multi-player game is to be played by users of two or more cellular phones, both the first and second cellular phones 10 and 12 need to have at least one multi-player game installed on them. To begin with, the first cellular phone 10 is connected to the server 14 through a cellular phone network. Next, the second cellular phone 12 is connected to the server 14 through the cellular phone network. Finally, users of the first cellular phone 10 and the second cellular phone 12 can play the game with one another through the server 14.

Alternately, the present invention also allows the user of the first cellular phone 10 to play against a computer-simulated player that is controlled by the server 14. In this case, the first cellular phone 10 needs to have at least one multi-player game installed on it. Next, the first cellular phone 10 is connected to the server 14 through a cellular phone network. Once the connection has been established, the first cellular phone 10 is able to play against the computer-simulated player controlled by the server 14.

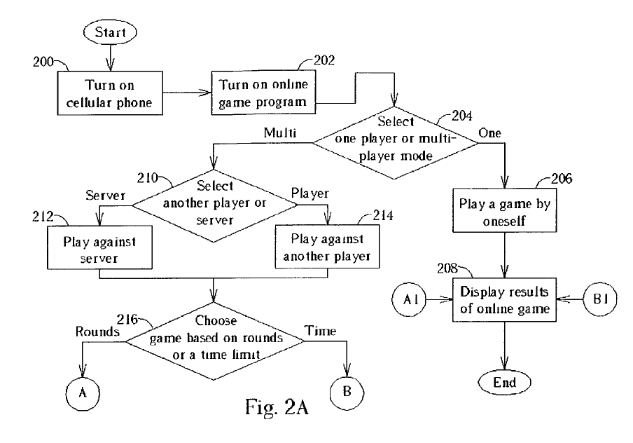

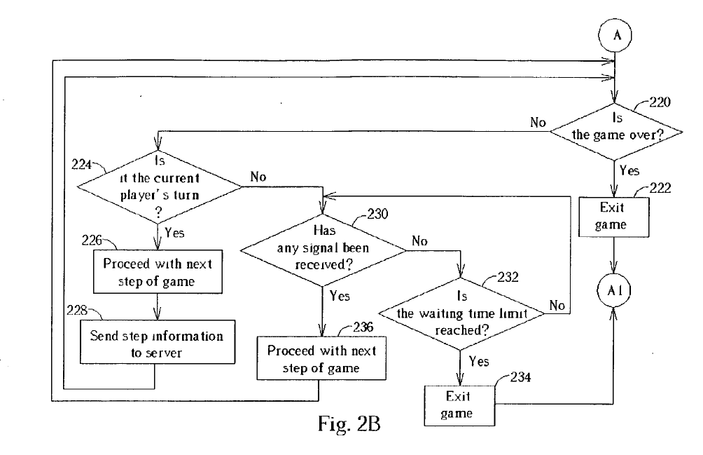

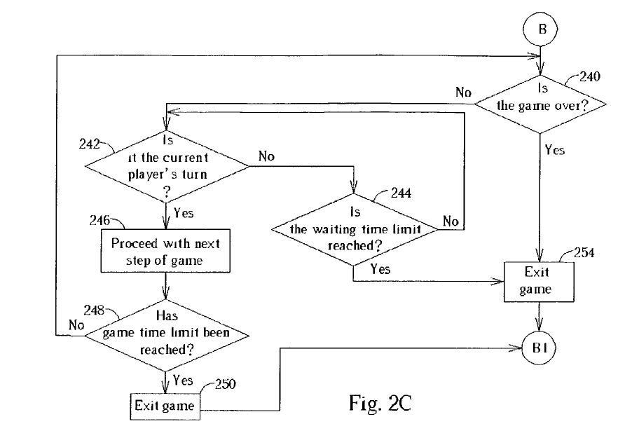

Please refer to FIGS. 2A to 2C. FIGS. 2A to 2C show a flowchart illustrating playing a game over the cellular phone network according to the present invention. Although any type of game can be played over the cellular phone network according to the present invention, for simplicity FIGS. 2A to 2C illustrate a single-player game and a multi-player game that is round-based or time-based in nature. That is, the winner is determined by winning a majority of rounds (such as 2 out of three rounds), or by winning before time expires or being in a winning position when time expires. Please note that FIGS. 2A to 2C make up one complete flow chart, and continuation markers A, B, A1, and B1 are used as connecting points between the parts of the flowchart. Also, please note that the flowchart is taken from the perspective of the user of one of the cellular phones, and the same steps are used for each of the multiple users.

Step 200: Turn on the cellular phone;

Step 202:

Turn on the online game program, which automatically connects the cellular phone to the server;

Step 204:

Select either one player mode or multi-player mode; if multi-player mode is selected, go to step 210; if one player mode is selected, go to step 206;

Step 206: Play the online game by oneself;

Step 208: Display the results of the online game; end;

Step 210: Select to play against another player or against a computer-simulated player controlled by the server; if the computer-simulated player controlled by the server is selected, go to step 212; if another player is selected, go to step 214;

Step 212: The online game will be played against the computer-simulated player controlled by the server, go to step 216;

Step 214: The online game will be played against the other player;

Step 216:

Select to play the a round-based game or a time-based game; if a round-based game is selected, go to step 220; if a time-based game is selected, go to step 240;

Step 220:

Check to see if the game has been completed by one player winning a majority of the rounds; if so, go to step 222; if not, go to step 224;

Step 222: Exit the online game, go to step 208;

Step 224:

Check to see if it is the current players turn; if so, go to step 226; if not, go to step 230;

Step 226: Proceed with the next step of the game, the current player takes his turn;

Step 228: Send information about the most recent turn to the server, go to step 220;

Step 230:

Since it is not the current players turn, check to see if there has been any signal received from the server; if so, go to step 236; if not, go to step 232;

Step 232:

Check to see if a maximum waiting time limit has been reached; the waiting time limit can be used to prevent excessive cellular phone charges from being accrued in the event of a loss of communication with the server; if the waiting time limit has been reached, go to step 234; if not, go to step 230;

Step 234: Exit the online game, go to step 208;

Step 236: Proceed with the next step of the game, go to step 220;

Step 240:C

heck to see if the game has been completed by one player winning before the game time expires or by being in a winning position when the game time expires; if so, go to step 254; if not, go to step 242;S

Step 242:

Check to see if it is the current players turn; if so, go to step 246; if not, go to step 244;

Step 244:

Check to see if a maximum waiting time limit has been reached; the waiting time limit can be used to prevent excessive cellular phone charges from being accrued in the event of a loss of communication with the server; if the waiting time limit has been reached, go to step 254; if not, go to step 242;

Step 246: Proceed with the next step of the game, the current player takes his turn;

Step 248:

Check to see if the game time limit has been reached; if so, go to step 250; if not, go to step 240;

Step 250: Exit the online game, go to step 208; and

Step 254: Exit the online game, go to step 208.

In summary, the user of the first cellular phone 10 can choose to play either a single player or a multi-player online game through the server 14 connected to the cellular phone network. If a multi-player game is chosen, the user can then choose whether to play against another player also using the second cellular phone 12, or against a computer-simulated player controlled by the server 14. In either multi-player game setting, a maximum waiting time limit is used to limit excessive cellular phone charges that could be accrued in the event of a loss of communication with the server. For example, if this preventative measure were not in place, a user of the first cellular phone 10 could maintain a connection to the server 14 for long periods of time even though the second cellular phone 12 had already lost connection with the server 14. By checking to see if the maximum waiting time has been reached, excessive call charges are kept to a minimum.

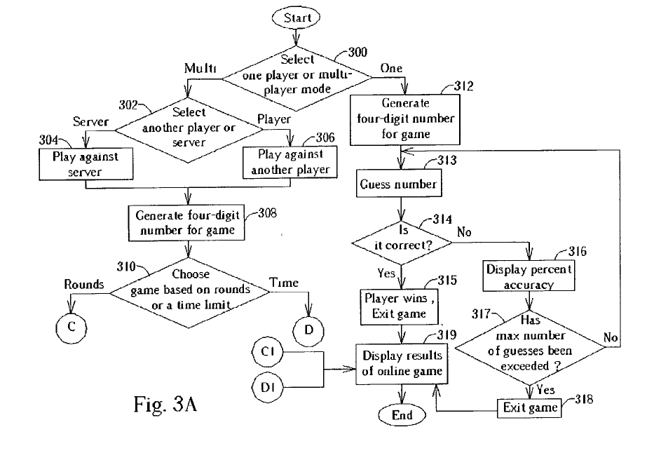

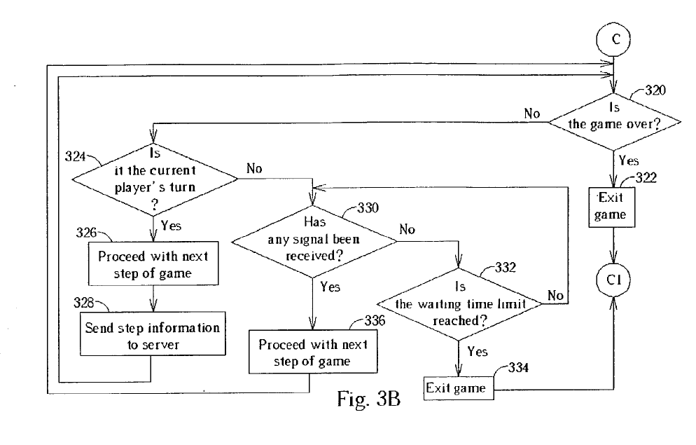

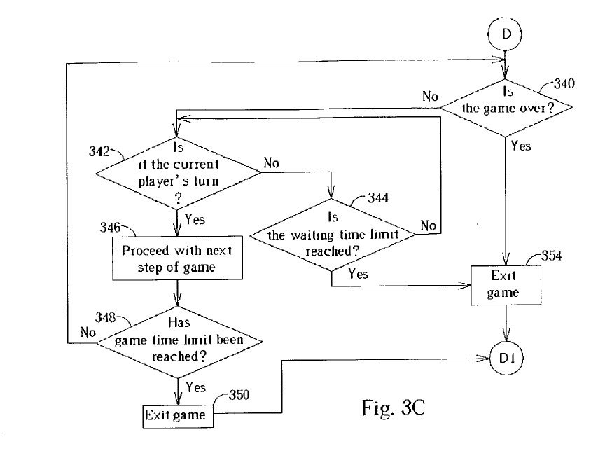

FIGS. 2A to 2C described a general game that could be played with one player or multiple players. Please refer to FIGS. 3A to 3C. FIGS. 3A to 3C show a flowchart illustrating playing a guessing game over the cellular phone network according to the present invention. As an example, a simple game involving guessing a four-digit number will be explained. In this case, a user would try to guess each digit in a four-digit number. Then, a percent accuracy can be displayed stating how many digits were correctly guessed. Suppose the number to be guessed was “5392”, and the player of the guessing game guessed “5891”. Since the first digit and the third digit were correctly guessed, the game would display a percent accuracy of 50%. The player of the game could then continue guessing until correctly guessing the four-digit number, or until a maximum number of guesses had been exceeded. As was the case in the general game explained in FIGS. 2A to 2C, the guessing game can also be played with one player or multiple players, and can also be a round-based or time-based game. Please note that FIGS. 3A to 3C make up one complete flow chart, and continuation markers C, D, C1, and D1 are used as connecting points between the parts of the flowchart.

Step 300:S

Select either one player mode or multi-player mode; if multi-player mode is selected, go to step 302; if one player mode is selected, go to step 312;S

Step 302:

Select to play against another player or against a computer-simulated player controlled by the server; if the computer-simulated player controlled by the server is selected, go to step 304; if another player is selected, go to step 306;

Step 304:

The online game will be played against the computer-simulated player controlled by the server, go to step 308;

Step 306: The online game will be played against the other player;

Step 308: Generate a four-digit number to be guessed in the guessing game;

Step 310:

Select to play the a round-based game or a time-based game; if a round-based game is selected, go to step 320; if a time-based game is selected, go to step 340;

Step 312: Generate a four-digit number to be guessed in the guessing game;

Step 313: The user guesses the four-digit number;

Step 314: Check to see if the four-digit number that the user guessed is equal to the four-digit number to be guessed; if so, go to step 315; if not, go to step 316;

Step 315: Player wins the game; exit the online game, go to step 319;

Step 316:

Since the guess was not correct, display percent accuracy of the four-digit number that the user guessed with respect to the four-digit number to be guessed;

Step 317:

Check to see if the maximum number of guesses has been exceeded for this game; if so, go to step 318; if not, go to step 313;

Step 318: Exit the online game;

Step 319: Display the results of the online game; end;

Step 320:

Check to see if the game has been completed by one player winning a majority of the rounds; if so, go to step 322; if not, go to step 324;

Step 322: Exit the online game, go to step 319;

Step 324:

Check to see if it is the current players turn; if so, go to step 326; if not, go to step 330;

Step 326: Proceed with the next step of the game, the current player takes his turn;

Step 328: Send information about the most recent turn to the server, go to step 320;

Step 330:

Since it is not the current players turn, check to see if there has been any signal received from the server; if so, go to step 336; if not, go to step 332;

Step 332:

Check to see if a maximum waiting time limit has been reached; the waiting time limit can be used to prevent excessive cellular phone charges from being accrued in the event of a loss of communication with the server; if the waiting time limit has been reached, go to step 334; if not, go to step 330;

Step 334: Exit the online game, go to step 319;

Step 336: Proceed with the next step of the game, go to step 320;

Step 340:

Check to see if the game has been completed by one player winning before the game time expires or by being in a winning position when the game time expires; if so, go to step 354; if not, go to step 342;

Step 342:

Check to see if it is the current players turn; if so, go to step 346; if not, go to step 344;

Step 344:

Check to see if a maximum waiting time limit has been reached; the waiting time limit can be used to prevent excessive cellular phone charges from being accrued in the event of a loss of communication with the server; if the waiting time limit has been reached, go to step 354; if not, go to step 342;

Step 346: Proceed with the next step of the game, the current player takes his turn;

Step 348:

Check to see if the game time limit has been reached; if so, go to step 350; if not, go to step 340;

Step 350: Exit the online game, go to step 319; and

Step 354: Exit the online game, go to step 319.

Compared to the prior art, the present invention method allows an online game to be played over a mobile communication network instead of simply playing a game locally residing on a mobile communication device, as was the case with the prior art. Using the present invention method, a user of the mobile communication device can play games with other players or with computer-simulated players through a server to make the game more enjoyable. In addition, mobile communication network owners also benefit since the games are played through phone calls made to the mobile communication network, which provides more revenue-earning opportunities.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for a user to play a game stored on a first mobile communication device over a mobile communication network, the method comprising:
connecting the first mobile communication device to a server of the mobile communication network in order to play the game over the mobile communication network; and
disconnecting the first mobile communication device with the server when the game is finished.

2. The method of claim 1 further comprising if the first mobile communication device does not receive signals from the server for a predetermined amount of time, disconnecting the first mobile communication device from the server.

3. The method of claim 1 further comprising:
connecting a second mobile communication device having the same game with the server; and
establishing a connection between the first and second mobile communication devices so that the first and second mobile communication devices are capable of interacting to play the game stored on the first and second mobile communication devices.

4. The method of claim 3 further comprising if the first mobile communication device does not receive signals from the second mobile communication device for a predetermined amount of time, disconnecting the first mobile communication device from the server.

5. The method of claim 1 further comprising terminating the game after a limited period of time.

6. The method of claim 1 further comprising terminating the game after a limited number of rounds.

7. The method of claim 6 wherein the game is won by winning a majority of the number of rounds.

8. The method of claim 1 wherein the first mobile communication device displays a game status while the game is being played.

9. The method of claim 1 wherein the first mobile communication device is a cellular phone.

10. The method of claim 1 wherein the mobile communication network is a cellular phone network.
